(19) United States
(12) Patent Application Publication
(10) Pub. No.: US 2003/0174203 A1
(43) Pub. Date: Sep. 18, 2003

(54) Image converter for providing flicker-free stereoscopic image based on top-down split frame sequential suitable for computer communications

(75) Inventors: Junichi Takeno, Kawasaki-shi (JP); Kazuo Okamoto, Yokohama-shi (JP)

Correspondence Address: CHARLES N.J. RUGGIERO, ESQ., OHLANDT, GREELEY, RUGGIERO & PERLE, L.L.P., 10th FLOOR, ONE LANDMARK SQUARE, STAMFORD, CT, 06901-2682, US

(73) Assignee: JUNICHI TAKENO

(21) Appl. No.: 10/346,959

(22) Filed: Jan. 17, 2003

Related U.S. Application Data
(63) Continuation of application No. PCT/JP01/06116, filed on Jul. 16, 2001.

(30) Foreign Application Priority Data
Jul. 19, 2000 (JP) 2000-251631

(51) Int. Cl. H04N 15/00; H04N 7/12

(52) U.S. Cl. 348/47; 375/240.01

(57) ABSTRACT

This device consists of image sending converter C which converts the image data obtained from at least two video cameras L and R, and image display converter D. C compresses the frame data which are simultaneously obtained from at least two video cameras L and R in parallel by using separate image compressing devices c1 which are synchronized mutually, concatenates the compressed image data, and sequentially converts concatenated data into computer's data stream called frame sequential. D is the device which reconfigures above converted data in the top-down split frame sequential format by using image separating device Q and image reconstructing device for stereoscopic image viewing.

### CROSS-REFERENCE TO RELATED APPLICATIONS

This is a Continuation Application of PCT Application No. PCT/JP01/06116, filed Jul. 16, 2001, which was not published under PCT Article 21(2) in English.

This application is based upon and claims the benefit of priority from the prior Japanese Patent Applications No. 2000-251631, filed Jul. 19, 2000, the entire contents of which are incorporated herein by reference.

### BACKGROUND OF THE INVENTION

1. Field of the Invention

The invention is related to image sending converter C which converts the image data obtained from at least two video cameras L and R into the format suitable for computer communications, and image display converter D. Converter C makes sequential compression of frame data which are synchronously obtained from at least two video cameras L and R individually and synchronously, then synthesizes said data into single data stream M. Converter D is the device for separating data stream M into individual data obtained from at least two right and left cameras, reconstructing each data to the image synchronously, using said data to sequentially configure the image frame for the computer which is displayed as stereoscopic image.

2. Description of the Related Art

We describe the conventional technology.

For display and transmission of stereoscopic image, various technologies have been suggested. For example, the famous technology enabling transmission of stereoscopic image is shown in US patent of Stereographics Corporation in USA (U.S. Pat. No. 4,523,226). Recently, Canon Inc. has disclosed the technology for distributing the stereoscopic image over Internet in Unexamined Patent Publication (JP 2000-184396 A, JP 2000-197074A). In the former technology, as video signals from individual right and left cameras are eventually converted into single video signal format, the image data amount from each camera must be reduced to half, disabling stereoscopic image with the highest-end resolution to be observed on the display. In the latter technology, though the purpose of distributing stereoscopic image over Internet is same as our purpose, it features reducing the video data from individual right and left cameras to half in the vertical direction, making single video data by concatenating the reduced data vertically, compressing the resultant video data sequentially, then distributing the compressed data over Internet. Accordingly, it is concluded that both of above two technologies reduce the resolution of the right- and left-camera images to half. Also, these two technologies employ the method that the image data is divided into two and arranged on the upper and lower subfields of top-down split screen simultaneously before displaying the video data from individual right and left cameras on the display three-dimensionally. Though this method seems the same as our method, the resolution of the image arranged on the upper and lower subfields of top-down split screen is reduced to half. Thus, it can be determined that the resultant stereoscopic image is not equipped with highest-end resolution.

Technology concerning how to transfer and display stereoscopic image is also shown in Unexamined Patent Publication of Hitachi Ltd. (JP 5-292544).

In its transfer technology, the image data obtained from the image pickup parts of right and left cameras are encoded by the individual encoder, and the each encoded data is multiplexed into single data VS by multiplexer, then transferred. At the receiving side, data VS is input into the demultiplexer in order to separate it into two encoded image data. Then, each data is input into the independent decoder to return it to the original right- and left-camera image data.

In its display technology, “selection circuit” is used and each of right- and left-camera image data is made high-resolution image data by using correction circuit and so on, concatenated alternately in the primary linear format, then output to the display in the time-division method at 1/120 second cycle, enabling flicker-free three-dimensional display.

In addition, according to Unexamined Patent Publication (JP 62-145993) of Sony Co., high-resolution three-dimensional display is realized by means of the device called “image producing part”. This device stores the right and left images in the frame memory in the format that right and left images are alternately concatenated while keeping high resolution, as well as outputs said image to the display at 120 Hz cycle, realizing high-resolution stereoscopic image.

Hitachi Ltd's transfer technology provides no guarantee for synchronization between right and left images on the computer network such as Internet due to “encoding the right and left image data by the separate encoder” and “sending the right and left image data to the transmission path via the multiplexing part”, which results in no guarantee for synchronization between right and left images received, thus no guarantee for producing stereoscopic image.

High-resolution stereoscopic display methods of Hitachi Ltd. and Sony employ the special device called “selection circuit” or “image producing part”, and outputs the right and left image data in the time-division method at 120 Hz cycle in order to realize stereoscopic image.

From these facts, there has been no such device which can send stereoscopic image over usual computer network such as Internet (LAN in FIG. 1, telephone line, broadcasting line, or usual computer network line) without deteriorating resolution, while maintaining synchronization between right and left image data at receiving time.

For display method, there has been no such technical idea that right and left images obtained from two video cameras are displayed simultaneously on upper and lower subfields of the top-down split screen in the frame (full field) without using the special device (generally called up-converter) “selection circuit” or “image producing part”.

Next, we describe the problem to be solved.

When transferring the stereoscopic image to the far site over computer network such as Internet, the well-known technology cannot guarantee that right and left images are received simultaneously and synchronously, even if these images are taken simultaneously. The reason is the following: when distributing stereoscopic image over computer network of which quality is not guaranteed such as Internet, there is the possibility of delay or missing of the data until the right and left image data are reproduced at the receiving side because the image data amount is relatively large against the bandwidth. Thus, the following two technologies must be established. The one is that the images taken from at least two video cameras can be distributed over computer network as far as possible, along with keeping synchronization between two images, that is, synchronization between right and left images in the event of stereoscopic image. Another is that high-resolution stereoscopic image can be displayed by using the usual PC functions at the receiving side, rather than the special device called “up-converter” which is required to see high-resolution stereoscopic image without flicker.

### BRIEF SUMMARY OF THE INVENTION

We describe the action to be taken to solve the conventional problem.

To solve above problem, capture each frame data (1-8 and 1-9 in FIG. 1) into device C of the computer (1-10 in FIG. 1) while synchronizing video cameras mutually (1-3 in FIG. 1), compress frame data Ln and Rn (where, n is natural number) in parallel while synchronizing separate image compressing devices c1 mutually, concatenate (frame sequential) the compressed data in the order of Ln and Rn (or reversely), and store the resultant data in the memory as the computer data ((d) or (d′) in FIG. 2). This series of operation facilitates stereoscopic image data required for stereoscopic image viewing to be handled by the computer. In this stereoscopic image data, right and left images which are synchronized once are configured as one pair of data before being sent to the computer network, reducing the possibility of out-of-synchronization during distribution over network.

If stereoscopic image data can be converted into the data to be stored in computer memory, the data equivalent to the image can easily be transferred to the far site over computer communications.

To reconstruct the received image data to the image and display the resultant data on the computer display, arrange each frame (full field) image from camera L (or R) and camera R (or L) sequentially on the upper and lower subfields of the top-down split screen in order to produce a single image frame of the computer (1-4 in FIG. 1). When displaying the top-down split images on the computer display, the environment which enables highest-end and high-resolution stereoscopic image is realized by separating the image data in the frame (full field) from camera L (1-6 or 1-7 in FIG. 1) from that in the frame (full field) from camera R (1-7 or 1-6 in FIG. 1), both of which are stored in computer's image frame, with vertical synchronous signal (1-5 in FIG. 1).

At this time, the image displayed on the computer display becomes flicker-free, because frequency of the usual vertical synchronous signal is automatically doubled (1-5 in FIG. 1). For example, if the usual computer display can display one frame in 60 Hz, separating the image data from camera L from that from camera R with vertical synchronous signal makes one frame be displayed in 120 Hz, enabling flicker-free image display.

### BRIEF DESCRIPTION OF THE SEVERAL VIEWS OF THE DRAWING

FIG. 1 shows the outline of the system invented.

FIG. 2 shows an example of input/output signal for the device invented.

### DETAILED DESCRIPTION OF THE INVENTION

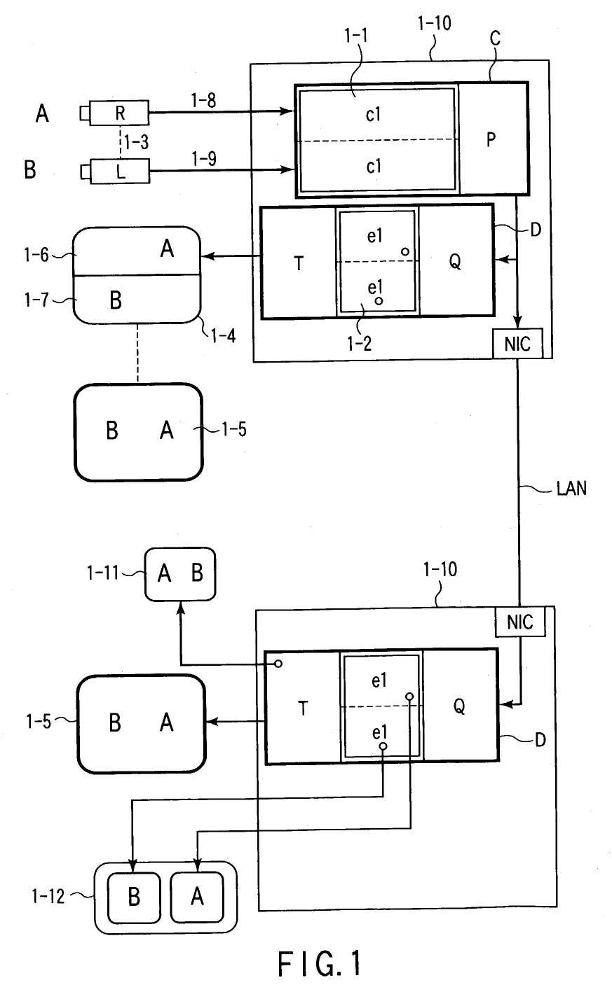

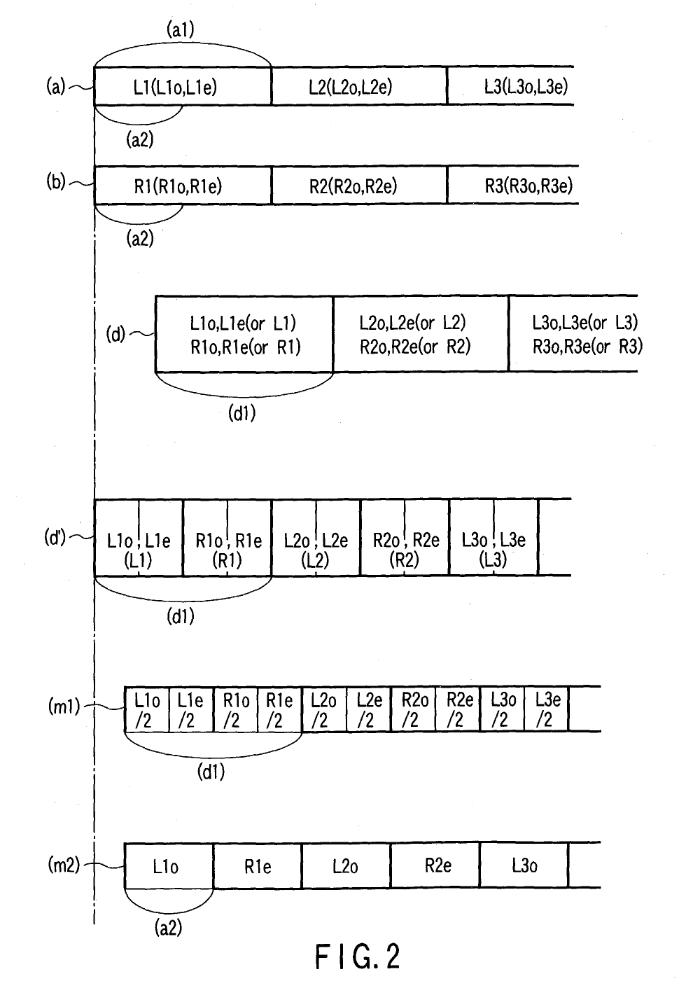

FIG. 1 shows the outline of the device and stereoscopic image viewing system invented. Also, FIG. 2 shows an example of data obtained from each part of the device in FIG. 1.

In FIG. 1, L and R are left and right cameras, respectively, capable of synchronously operating. 1-10 is computer having device C as encoder and device D as decoder according to the present invention.

Device C comprises image compressing devices c1, c1 for capturing an image and compressing the image, and data concatenating device P for converting compressed image data from image compressing devices c1, c1 into frame sequential data.

Device D as decoder has image separating device Q, image reconstructing devices e1, e1, and restructuring device T. Image separating device Q separates frame sequential data into right and left image data. Image reconstructing devices e1, e1 reconstruct right and left compressed image data which are separated. Restructuring device T has buffer memory, and restructures data which is reconstructed full field image data and frame sequential data as data for display.

It is possible to transfer stereoscopic image data from first computer 1-10 to second computer 1-10. This data is transferred through, for example, network interface card NIC and LAN. Second computer 1-10 is also provided with device D similar to decoder described above.

In display 1-4, right and left full field images 1-6 and 1-7 output from restructuring device T are divided and displayed on the upper and lower subfields of the top-down split screen. Also, display 1-5 shows right and left full field images output from restructuring device T which are alternately displayed in which vertical synchronous frequency is doubled.

In FIG. 2, (a) and (b) show image signals output from cameras L and R. Suffixes o and e means odd field and even field, respectively. Term (a1) is (1/30) seconds, and term (a2) is (1/60) seconds.

In FIG. 2, (d) indicates frame sequential data stream. Each frame block data is independent. One item of frame block data includes right and left compressed full field image data.

Here, header is attached to leading of each frame block data to facilitate separation and compression of blocks. This header includes identification data about stereoscopic data and frame data.

(d′) in FIG. 2 is more detailed example of each frame block data. This data stream is one example, and limitation is not made to such stream.

The above system has features that (1) cameras L and R are synchronized, (2) image compressing devices c1, c1 synchronously compress images, and (3) data concatenating device P produces frame sequential stream as shown in (d) in FIG. 2.

Synchronization of cameras L and R can be realized by supplying synchronous signal of one camera to the other camera. However, synchronous signals of cameras L and R may be given from image compressing device c1.

Common clock is used in order that image compressing devices c1, c1 synchronously operate. Accordingly, image compressing devices c1, c1 are connected to synchronizing means. For example, output clock and timing pulse of a single timing pulse generating device are supplied to two image compressing devices c1, c1. Also, the timing pulse generating device is configured to be synchronized with synchronous pulses received from cameras L and R in phase.

Next, we describe operation through the entire.

The key of the invention is image sending converter device C and image displaying converter device D.

Device C uses each frame image from at least two synchronized cameras R and L as the input data ((a) and (b) in FIG. 2) simultaneously, compresses said data in parallel while synchronizing them mutually by separate image compressing device c1 (1-1 in FIG. 1), produces output data stream M which is called frame sequential form by sequentially concatenating compressed data by means of data concatenating device P ((d) in FIG. 2). Output stream M can easily be stored in the computer's internal memory as the image data. c1 in FIG. 1 is the image capturing and image compressing device. In the implementation example in FIG. 1, the image is compressed in simultaneous and parallel manner by synchronizing at least as many c1s as number of cameras. The frame data from both cameras which are compressed are input into data concatenating device P, resulting in frame sequential image data stream M ((d) in FIG. 2). Frame-sequential-form data stream is an image data stream, which is produced by compressing and synthesizing the image signals in each image frame (full field) obtained by at least two synchronized video cameras ((d) in FIG. 2). Detailed example of data stream M is shown in (d′) in FIG. 2. (d1) in FIG. 2 is configured at least as 60 Hz in the usual computer image. (a1) in FIG. 2 is one video frame which is configured as 30 Hz in the usual video image, while (a2) is one video field which is configured as 60 Hz.

(m1) and (m2) in FIG. 2 are stereoscopic image data with conventional configuration. It is clear that resolution of both data is reduced to half. Accordingly, in the conventional configuration, each frame data is half the data of the present invention.

Device D reconfigures (device T) the output or sent image data stream in the top-down split frame sequential form through image separating device Q and at least one image reconstructing device (e1 in FIG. 1). In the implementation example in FIG. 1, as many image reconstructing devices e1 as the number of cameras are arranged, which reconstruct the image taking synchronization mutually (1-2 in FIG. 1).

No needless to say, device D can realize stereoscopic image viewing by using two or more displays as shown in 1-12 or 1-11 in FIG. 1, or using the stereoscopic-viewing-enabled display.

This device is mainly used as a part of visual functions for remote operation of the robot, because it can easily distribute stereoscopic image over usual communications line (LAN in FIG. 1, telephone line, broadcasting line, or usual computer network line) by converting the image for viewing stereoscopic image which consists of images obtained from at least two video cameras (R and L in FIG. 1). This device can be used for electronic commerce over Internet with stereoscopic image viewing, because it enables high-resolution stereoscopic image viewing from the far site over usual Internet. This device can be used for net game in which the game using stereoscopic image is realized on Internet. This device enables exhibition of the commodities in stereoscopic image on Internet. This device enables world-wide distribution of stereoscopic image from anywhere in the world, realizing more realistic data exchange.

What is claimed is:

1. The device consisting of image sending converter C which converts the image data obtained from at least two video cameras L and R into the format suitable for computer communications, and image display converter D. C is the device which inputs the frame data obtained from at least two synchronized vide cameras L and R into the separate image compressing device c1, compresses the image in parallel while synchronizing cis mutually, concatenates the compressed image data by using image concatenating device P, and sequentially converts concatenated data into frame sequential to produce single data stream M. D is the device which separates data stream M into above compressed image data obtained from at least two video cameras by using image separating unit Q, inputs sequentially each compressed image data into the image reconstructing device to reconfigure each image frame, and arranges each reconstructed image frame, that is full field image, on the upper and lower subfields of the top-down split screen so that the right and left images are displayed as a single image.

2. A stereoscopic image data processing device comprising:
a first image compressing device to which left image data from a left camera is input;
a second image compressing device to which right image data from a right camera which is synchronized with the left camera is input;
synchronizing means for giving a common timing pulse to both the image compressing devices to synchronize image compression by the first and second image compressing devices; and
a data concatenating device for constructing compressed image data obtained from the first and second image compressing devices as block data, independent, including the left and right image data, and outputting the block data as frame sequential data.

3. The device according to claim 2, wherein the block data includes right and left compressed full filed image data.
